(19) United States
(12) Patent Application Publication
(10) Pub. No.: US 2020/0302139 A1
(43) Pub. Date: Sep. 24, 2020

(54) FINGERPRINT IDENTIFICATION DEVICE, FINGERPRINT IDENTIFICATION METHOD, AND METHOD FOR MANUFACTURING THE FINGERPRINT IDENTIFICATION DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Xiaoliang FENG, Wuhan, Hubei (CN)

(21) Appl. No.: 16/342,213

(22) PCT Filed: Mar. 19, 2019
(86) PCT No.: PCT/CN2019/078627

§ 371 Date: Apr. 16, 2019

(51) Int. Cl. G06K 9/00

(52) U.S. Cl. CPC G06K 9/0002; G06K 9/00087

(57) ABSTRACT

A fingerprint identification device, a fingerprint identification method, and a method for manufacturing the fingerprint identification device are provided. The fingerprint identification device includes a fingerprint identification unit, a control circuit unit, and a connection component. The fingerprint identification unit includes at least one thermosensitive wire layer and is configured to sense a fingerprint of a user's finger through the at least one thermosensitive wire layer. The control circuit unit is disposed at one side of the fingerprint identification unit and is electrically connected to the fingerprint identification unit. The connection component is connected to the fingerprint identification unit and the control circuit unit.

### FIELD OF INVENTION

The present disclosure relates to the field of display technologies, and more particularly to a fingerprint identification device, a fingerprint identification method, and a method for manufacturing the fingerprint identification device.

### BACKGROUND OF INVENTION

With development of technologies, fingerprint identification devices are being used more and more widely in various electronic devices. For example, if a current smartphone including a fingerprint identification device is provided, a user can perform functions such as unlocking the smartphone and paying for bill for a fingerprint identification through the fingerprint identification device.

At present, fingerprint identification devices of electronic devices usually use push-type fingerprint sensors, for example, mobile terminals such as APPLE'IPHONE 5S, IPHONE 6, and IPHONE 6S. With the development of technologies, fingerprint identification technologies have further appeared in a new trend, such as applications to full screens and in-cell display screens, etc. Current fingerprint identification devices have certain defects and cannot meet higher requirements.

Therefore, there is a need to provide a fingerprint identification device, a fingerprint identification method, and a method for manufacturing the fingerprint identification device to solve issues of the prior art.

### SUMMARY OF INVENTION

To solve the above technical problem, the present disclosure provides a fingerprint identification device including a fingerprint identification unit, a control circuit unit, and a connection component. The fingerprint identification unit includes at least one thermosensitive wire layer and is configured to sense a fingerprint of a user's finger through the at least one thermosensitive wire layer. The control circuit unit is disposed at one side of the fingerprint identification unit and is electrically connected to the fingerprint identification unit. The connection component is connected to the fingerprint identification unit and the control circuit unit. The at least one thermosensitive wire layer includes a first thermosensitive wire layer and a second thermosensitive wire layer, the first thermosensitive wire layer includes a plurality of longitudinal thermosensitive wires, the second thermosensitive wire layer includes a plurality of transverse thermosensitive wires, and the longitudinal thermosensitive wires and the transverse thermosensitive wires intersect to define a plurality of sensing regions. Two ends of each of the longitudinal thermosensitive wires and two ends of each of the transverse thermosensitive wires are electrically connected to the control circuit unit.

In an embodiment of the present disclosure, a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

In an embodiment of the present disclosure, the fingerprint identification unit further includes a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

In an embodiment of the present disclosure, the fingerprint identification unit further includes a protective layer disposed on the longitudinal thermosensitive wires and the transverse thermosensitive wires.

The present disclosure further provides a fingerprint identification device including a fingerprint identification unit, a control circuit unit, and a connection component. The fingerprint identification unit includes at least one thermosensitive wire layer and is configured to sense a fingerprint of a user's finger through the at least one thermosensitive wire layer. The control circuit unit is disposed at one side of the fingerprint identification unit and is electrically connected to the fingerprint identification unit. The connection component is connected to the fingerprint identification unit and the control circuit unit.

In an embodiment of the present disclosure, the at least one thermosensitive wire layer includes a first thermosensitive wire layer and a second thermosensitive wire layer, the first thermosensitive wire layer includes a plurality of longitudinal thermosensitive wires, the second thermosensitive wire layer includes a plurality of transverse thermosensitive wires, and the longitudinal thermosensitive wires and the transverse thermosensitive wires intersect to define a plurality of sensing regions.

In an embodiment of the present disclosure, two ends of each of the longitudinal thermosensitive wires and two ends of each of the transverse thermosensitive wires are electrically connected to the control circuit unit.

In an embodiment of the present disclosure, a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

In an embodiment of the present disclosure, the fingerprint identification unit further includes a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

In an embodiment of the present disclosure, the fingerprint identification unit further includes a protective layer disposed on the longitudinal thermosensitive wires and the transverse thermosensitive wires.

The present disclosure further provides a fingerprint identification method applied to the fingerprint identification device. The fingerprint identification method includes sensing the fingerprint of the user's finger using the at least one thermosensitive wire layer, when the at least one thermosensitive wire layer senses the fingerprint of the user's finger, using the at least one thermosensitive wire layer to sense a temperature change and feedback, to the control circuit unit, a resistance change, using the control circuit unit to determine a fingerprint pattern of the user's finger according to an amount of the resistance change and collect the fingerprint pattern, matching the fingerprint pattern with a preset fingerprint pattern, and if the fingerprint pattern and the preset fingerprint pattern match, it is determined that an identification of the fingerprint pattern is successful.

In an embodiment of the present disclosure, the at least one thermosensitive wire layer includes a first thermosensitive wire layer and a second thermosensitive wire layer, the first thermosensitive wire layer includes a plurality of longitudinal thermosensitive wires, the second thermosensitive wire layer includes a plurality of transverse thermosensitive wires, and the longitudinal thermosensitive wires and the transverse thermosensitive wires intersect to define a plurality of sensing regions.

In an embodiment of the present disclosure, two ends of each of the longitudinal thermosensitive wires and two ends of each of the transverse thermosensitive wires are electrically connected to the control circuit unit.

In an embodiment of the present disclosure, a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

In an embodiment of the present disclosure, the fingerprint identification unit further includes a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

In an embodiment of the present disclosure, the fingerprint identification unit further includes a protective layer disposed on the longitudinal thermosensitive wires and the transverse thermosensitive wires.

The present disclosure further provides a method for manufacturing a fingerprint identification device. The method for manufacturing the fingerprint identification device includes providing a fingerprint identification unit, wherein the fingerprint identification unit includes at least one thermosensitive wire layer and is configured to sense a fingerprint of a user's finger through the at least one thermosensitive wire layer, forming a control circuit unit at one side of the fingerprint identification unit, wherein the control circuit unit is electrically connected to the fingerprint identification unit, and forming a connection component, wherein the connection component connects the fingerprint identification unit and the control circuit unit.

In an embodiment of the present disclosure, the at least one thermosensitive wire layer includes a first thermosensitive wire layer and a second thermosensitive wire layer, the first thermosensitive wire layer includes a plurality of longitudinal thermosensitive wires, the second thermosensitive wire layer includes a plurality of transverse thermosensitive wires, and the longitudinal thermosensitive wires and the transverse thermosensitive wires intersect to define a plurality of sensing regions.

In an embodiment of the present disclosure, a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

In an embodiment of the present disclosure, the fingerprint identification unit further includes a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

Compared with the prior art, in order to solve the above technical problem, the fingerprint identification device, the fingerprint identification method, and the method for manufacturing the fingerprint identification device of the embodiments of the present disclosure can realize fingerprint identification through at least one thermosensitive wire layer and can intuitively feedback sensitivity and precision of fingerprint graphics and fingerprint identification.

### DESCRIPTION OF DRAWINGS

FIG. 1 is a schematic structural diagram of a fingerprint identification device according to an embodiment of the present disclosure.

FIG. 2 is a schematic structural diagram of a fingerprint identification unit according to an embodiment of the present disclosure.

FIG. 3 is a schematic structural diagram of a fingerprint identification unit according to an embodiment of the present disclosure.

FIG. 4 is a schematic diagram illustrating a resistance of at least one thermosensitive wire layer changes with temperature according to an embodiment of the present disclosure.

FIG. 5 is a block diagram of a fingerprint identification method according to an embodiment of the present disclosure.

FIG. 6 is a block diagram of a method for manufacturing a fingerprint identification device according to an embodiment of the present disclosure.

### DETAILED DESCRIPTION OF PREFERRED EMBODIMENTS

The following description of the various embodiments is provided to illustrate the specific embodiments with reference to the accompanying drawings.

In order to make the above description of the present disclosure and other objects, features, and advantages of the present disclosure more comprehensible, preferred embodiments are described below, and are described in detail below with reference to the accompanying drawings. Furthermore, directional terms described by the present disclosure, such as up, down, top, bottom, front, back, left, right, inner, outer, side, surrounding, center, horizontal, vertical, longitudinal, axial, radial, uppermost or lowermost, etc., are only directions by referring to the accompanying drawings, and thus the used terms are used only for the purpose of describing embodiments of the present disclosure and are not intended to be limiting of the present disclosure.

In the drawings, units with similar structures are labeled with the same reference number.

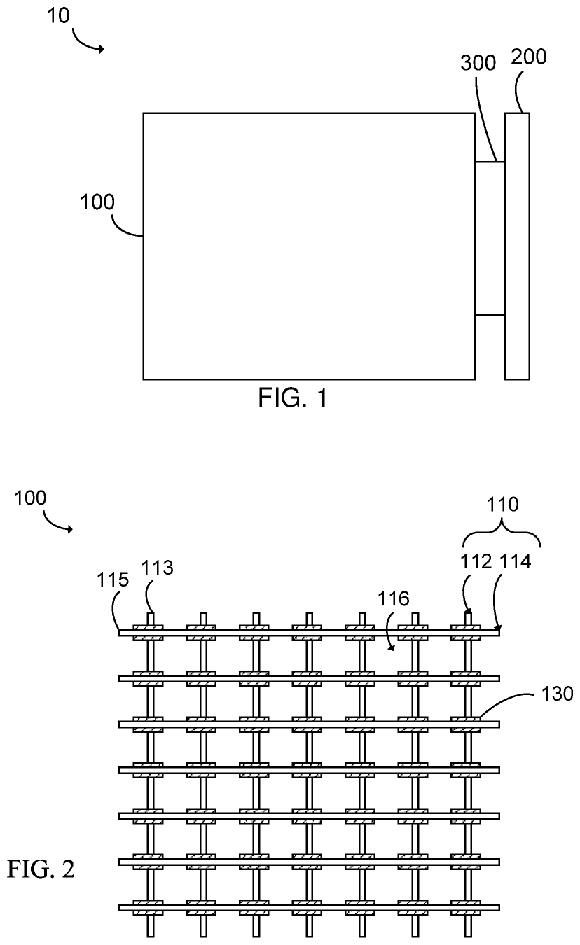

Referring to FIGS. 1 and 2, a fingerprint identification device 10 of an embodiment of the present disclosure includes a fingerprint identification unit 100, a control circuit unit 200, and a connection component 300. The fingerprint identification unit 100 includes at least one thermosensitive wire layer 110 and is configured to sense a fingerprint of a user's finger through the at least one thermosensitive wire layer 110. The control circuit unit 200 is disposed at one side of the fingerprint identification unit 100 and is electrically connected to the fingerprint identification unit 100. The connection component 300 is connected to the fingerprint identification unit 100 and the control circuit unit 200.

Because the fingerprint identification device 10 of the embodiment of the present disclosure performs fingerprint identification through at least one thermosensitive wire layer 110, the fingerprint identification device 10 can intuitively feedback sensitivity and precision of fingerprint graphics and fingerprint identification.

In details, an electronic device includes the fingerprint identification device 10.

In details, the control circuit unit 200 is, for example, an integrated circuit (IC) unit configured to process fingerprint identification related signals and/or messages.

Referring to FIGS. 1 to 3, in details, the at least one thermosensitive wire layer 110 includes a first thermosensitive wire layer 112 and a second thermosensitive wire layer 114. The first thermosensitive wire layer 112 includes a plurality of longitudinal thermosensitive wires 113, the second thermosensitive wire layer 114 includes a plurality of transverse thermosensitive wires 115. The longitudinal thermosensitive wires 113 and the transverse thermosensitive wires 115 intersect to define a plurality of sensing regions 116.

In details, two ends of each of the longitudinal thermosensitive wires 113 and two ends of each of the transverse thermosensitive wires 115 are electrically connected to the control circuit unit 200. A material of the longitudinal thermosensitive wires 113 and a material of the transverse thermosensitive wires 115 are selected from the group consisting of at least one of copper, silver, nickel, platinum, a cobalt base alloy, a nickel base alloy, and a ferrous alloy.

In details, the fingerprint identification unit 100 further includes a substrate 120 and an insulating layer 130. The first thermosensitive wire layer 112 and the second thermosensitive wire layer 114 are disposed on the substrate 120. The insulating layer 130 is disposed at an intersection of the longitudinal thermosensitive wires 113 and the transverse thermosensitive wires 115. The fingerprint identification unit 100 further includes a protective layer 140 disposed on the longitudinal thermosensitive wires 113 and the transverse thermosensitive wires 115.

Referring to FIGS. 1 to 4, in details, a resistance of the at least one thermosensitive wire layer 110 changes significantly with temperature. Because the at least one thermosensitive wire layer 110 changes with temperature, as illustrated in FIG. 4, as a temperature of the at least one thermosensitive wire layer 110 rises, the resistance of the at least one thermosensitive wire layer 110 decreases. With this property, when a finger touches a surface of the fingerprint identification device 10, there is a temperature difference at a contact surface of the fingerprint identification device 10 due to presence of a fingerprint peak and a fingerprint valley, thereby causing a resistance change of the at least one thermosensitive wire layer 110. According to a resistance signal, the control circuit unit 200 in FIG. 1 converts into a graphic message. A thermistor can sense a temperature change of 0.001 K at the lowest, and the test sensitivity is high. A position of a grid line defined by the first thermosensitive wire layer 112 and the second thermosensitive wire layer 114 realizes positioning of a temperature change point.

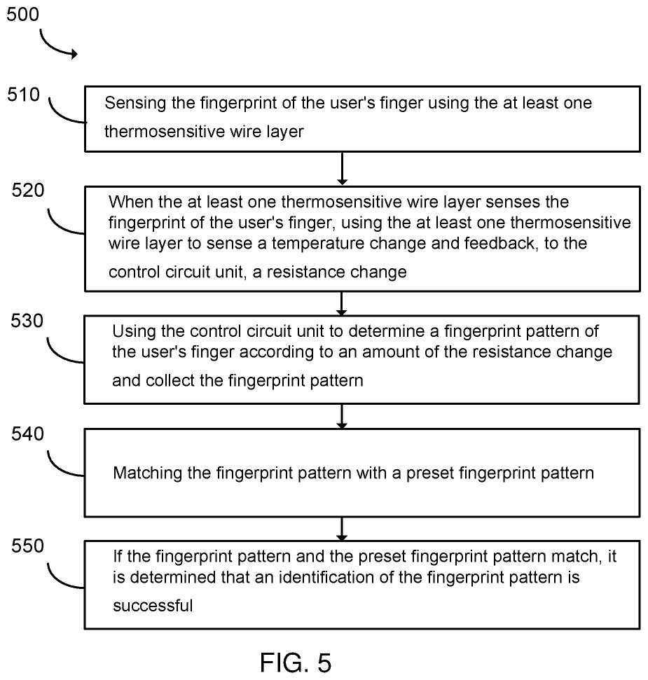

Referring to FIG. 5, an embodiment of the present disclosure further provides a fingerprint identification method 500 applied to the fingerprint identification device 10. The fingerprint identification method 500 includes: at a block 510, sensing the fingerprint of the user's finger using the at least one thermosensitive wire layer 110, at a block 520, when the at least one thermosensitive wire layer 110 senses the fingerprint of the user's finger, using the at least one thermosensitive wire layer 110 to sense a temperature change and feedback, to the control circuit unit 200, a resistance change, at a block 530, using the control circuit unit 200 to determine a fingerprint pattern of the user's finger according to an amount of the resistance change and collect the fingerprint pattern, at a block 540, matching the fingerprint pattern with a preset fingerprint pattern, and at a block 550, if the fingerprint pattern and the preset fingerprint pattern match, it is determined that an identification of the fingerprint pattern is successful.

In details, the user's finger touches a screen surface of the electronic device, and the at least one thermosensitive wire layer 110 senses a temperature change, and a resistance of the at least one thermosensitive wire layer 110 changes, and the resistance change fed back by the at least one thermosensitive wire layer 110 is processed by the control circuit unit 200. The control circuit unit 200 performs graphical deformation and correlates with current fingerprint patterns to implement unlocking or password service of the electronic device.

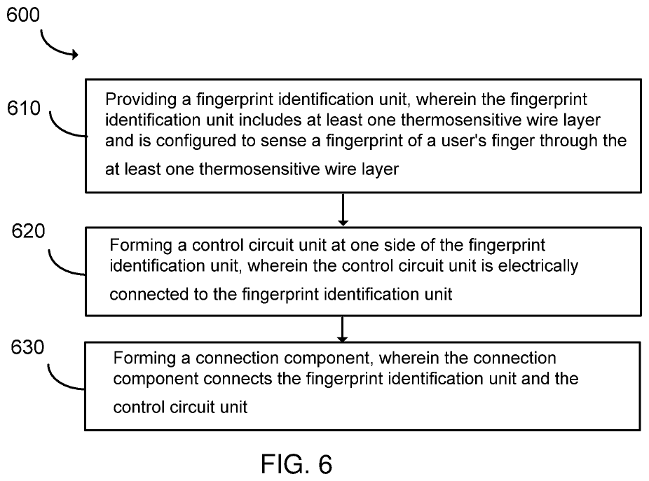

Referring to FIG. 1 and FIG. 6, an embodiment of the present disclosure further provides a method 600 for manufacturing the fingerprint identification device 10. The method 600 for manufacturing the fingerprint identification device 10 includes: at a block 610, providing the fingerprint identification unit 100, wherein the fingerprint identification unit 100 includes the at least one thermosensitive wire layer 110 and is configured to sense a fingerprint of a user's finger through the at least one thermosensitive wire layer 110, at a block 620, forming the control circuit unit 200 at one side of the fingerprint identification unit 100, wherein the control circuit unit 200 is electrically connected to the fingerprint identification unit 100, and at a block 630, forming the connection component 300, wherein the connection component 300 connects the fingerprint identification unit 100 and the control circuit unit 200.

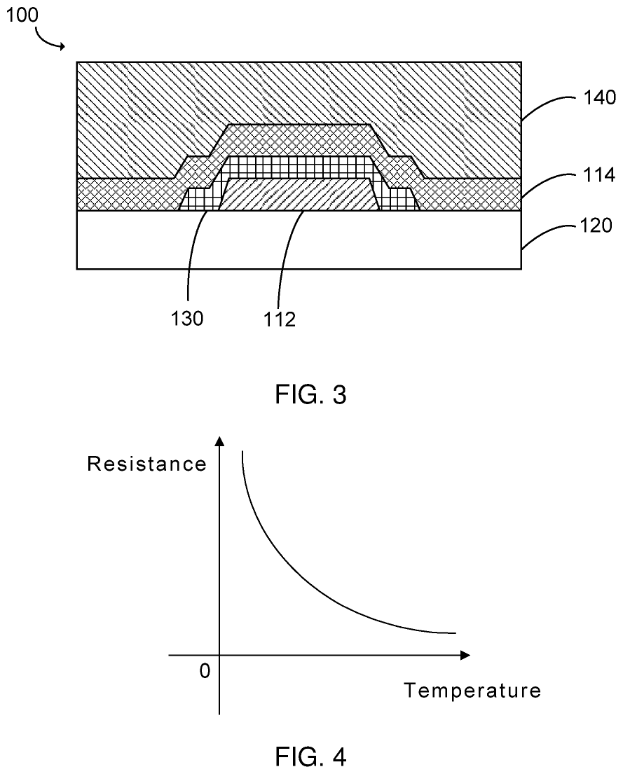

In details, referring to FIG. 2 and FIG. 3, in the embodiment of the present disclosure, the first thermosensitive wire layer 112 and the second thermosensitive wire layer 114 are formed on the substrate 120. The insulating layer 130 is disposed at an intersection of the first thermosensitive wire layer 112 and the second thermosensitive wire layer 114 for insulation protection.

In details, first, the first thermosensitive wire layer 112 is formed on the substrate 120, and a wire shape thereof is formed by a process such as plating, exposure, etching, or the like. Thereafter, the insulating layer 130 is formed, and if an inorganic insulating film is used, a pattern can be formed by a process such as plating, exposure, etching, or the like. If an organic insulating film is used, the organic insulating film can be molded by exposure. Thereafter, the second thermosensitive wire layer 114 is formed, and a wire pattern thereof is formed by a process such as plating, exposure, etching, or the like. Thereafter, the protective layer 140 is formed, and an inorganic insulating film or an organic insulating film can also be used.

In details, the substrate 120 may be a glass substrate, a ceramic substrate, a polyimide (PI) substrate, a polyethylene terephthalate (PET) substrate, or a cycloolefin polymer (COP) substrate or the like. The substrate 120 may have transparent material or non-transparent material. The substrate 120 having transparent material can be placed on a surface of a display screen of an electronic device, or the display screen itself can be used as the substrate 120.

The above process can be used as a general process, but is not limited to the above process. It is also possible to produce a film pattern of the same performance by processes such as embossing, letterpress printing, and laser etching.

The embodiment of the present disclosure provides a fingerprint identification device that can be used independently or combined with a display screen of an electronic device to adapt to a full-screen design.

In the embodiment of the present disclosure, a fingerprint coordinate map is established by using a thermosensitive material, and a fingerprint position and shape are sensed by different temperatures of contact with the finger, thereby implementing the fingerprint identification technology.

Because the fingerprint identification device, the fingerprint identification method, and the method for manufacturing the fingerprint identification device of the embodiment of the present disclosure, fingerprint identification can realize fingerprint identification through at least one thermosensitive wire layer and can intuitively feedback sensitivity and precision of fingerprint graphics and fingerprint identification. In addition, the manufacturing process thereof is simple, materials used thereof are easy to obtain, and the process operation thereof is convenient. The fingerprint identification device can be attached to a target product (for example, an electronic device) as an external product, or can be made as a process layer inside the target product.

Although the present disclosure is described via one or more embodiments, those of ordinary skill in the art can come up with equivalent variations and modifications based upon the understanding of the specification and the accompanying drawings. The present disclosure includes all such modifications and variations, and is only limited by the scope of the appended claims. In particular, as to the various functions performed by the components described above, the terms used to describe the components are intended to correspond to any component performing the specific functions (e.g., which are functionally equivalent) of the components (unless otherwise indicated), even those which are structurally different from the disclosed structure for performing the functions in the exemplary embodiments in the specification shown herein. In addition, although a particular feature in the specification is disclosed in only one of many embodiments, this feature may be combined with one or more features in other embodiments which are desirable and advantageous to a given or particular application. Moreover, the terms “include”, “have”, “consist of”, or variations thereof used in the detailed description or the claims are intended to be used in a manner similar to the term “comprising”.

In summary, although the preferable embodiments of the present disclosure have been disclosed above. It should be noted that those of ordinary skill in the art can make a variety of improvements and substitutions on the premise of not deviating from the technical principle of the present disclosure, and these improvements and substitutions should be encompassed within the protection scope of the present disclosure.

What is claimed is:

1. A fingerprint identification device, comprising:
a fingerprint identification unit comprising at least one thermosensitive wire layer, wherein the fingerprint identification unit is configured to sense a fingerprint of a user's finger through the at least one thermosensitive wire layer;
a control circuit unit disposed at one side of the fingerprint identification unit and electrically connected to the fingerprint identification unit; and
a connection component connecting the fingerprint identification unit and the control circuit unit;
wherein the at least one thermosensitive wire layer comprises a first thermosensitive wire layer and a second thermosensitive wire layer, the first thermosensitive wire layer comprises a plurality of longitudinal thermosensitive wires, the second thermosensitive wire layer comprises a plurality of transverse thermosensitive wires, and the longitudinal thermosensitive wires and the transverse thermosensitive wires intersect to define a plurality of sensing regions;
wherein two ends of each of the longitudinal thermosensitive wires and two ends of each of the transverse thermosensitive wires are electrically connected to the control circuit unit.

2. The fingerprint identification device according to claim 1, wherein a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

3. The fingerprint identification device according to claim 1, wherein the fingerprint identification unit further comprises a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

4. The fingerprint identification device according to claim 3, wherein the fingerprint identification unit further comprises a protective layer disposed on the longitudinal thermosensitive wires and the transverse thermosensitive wires.

5. A fingerprint identification device, comprising:
a fingerprint identification unit comprising at least one thermosensitive wire layer, wherein the fingerprint identification unit is configured to sense a fingerprint of a user's finger through the at least one thermosensitive wire layer;
a control circuit unit disposed at one side of the fingerprint identification unit and electrically connected to the fingerprint identification unit; and
a connection component connecting the fingerprint identification unit and the control circuit unit.

6. The fingerprint identification device according to claim 5, wherein the at least one thermosensitive wire layer comprises a first thermosensitive wire layer and a second thermosensitive wire layer, the first thermosensitive wire layer comprises a plurality of longitudinal thermosensitive wires, the second thermosensitive wire layer comprises a plurality of transverse thermosensitive wires, and the longitudinal thermosensitive wires and the transverse thermosensitive wires intersect to define a plurality of sensing regions.

7. The fingerprint identification device according to claim 6, wherein two ends of each of the longitudinal thermosensitive wires and two ends of each of the transverse thermosensitive wires are electrically connected to the control circuit unit.

8. The fingerprint identification device according to claim 6, wherein a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

9. The fingerprint identification device according to claim 6, wherein the fingerprint identification unit further comprises a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

10. The fingerprint identification device according to claim 9, wherein the fingerprint identification unit further comprises a protective layer disposed on the longitudinal thermosensitive wires and the transverse thermosensitive wires.

11. A fingerprint identification method applied to the fingerprint identification device according to claim 1, comprising:
sensing the fingerprint of the user's finger using the at least one thermosensitive wire layer;
when the at least one thermosensitive wire layer senses the fingerprint of the user's finger, using the at least one thermosensitive wire layer to sense a temperature change and feedback, to the control circuit unit, a resistance change;
using the control circuit unit to determine a fingerprint pattern of the user's finger according to an amount of the resistance change and collect the fingerprint pattern;
matching the fingerprint pattern with a preset fingerprint pattern; and
if the fingerprint pattern and the preset fingerprint pattern match, it is determined that an identification of the fingerprint pattern is successful.

12. The fingerprint identification method according to claim 11, wherein the at least one thermosensitive wire layer comprises a first thermosensitive wire layer and a second thermosensitive wire layer, the first thermosensitive wire layer comprises a plurality of longitudinal thermosensitive wires, the second thermosensitive wire layer comprises a plurality of transverse thermosensitive wires, and the longitudinal thermosensitive wires and the transverse thermosensitive wires intersect to define a plurality of sensing regions.

13. The fingerprint identification method according to claim 12, wherein two ends of each of the longitudinal thermosensitive wires and two ends of each of the transverse thermosensitive wires are electrically connected to the control circuit unit.

14. The fingerprint identification method according to claim 12, wherein a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

15. The fingerprint identification method according to claim 12, wherein the fingerprint identification unit further comprises a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.

16. The fingerprint identification method according to claim 15, wherein the fingerprint identification unit further comprises a protective layer disposed on the longitudinal thermosensitive wires and the transverse thermosensitive wires.

17. A method for manufacturing a fingerprint identification device, comprising:
providing a fingerprint identification unit, wherein the fingerprint identification unit comprises at least one thermosensitive wire layer and is configured to sense a fingerprint of a user's finger through the at least one thermosensitive wire layer;
forming a control circuit unit at one side of the fingerprint identification unit, wherein the control circuit unit is electrically connected to the fingerprint identification unit; and
forming a connection component, wherein the connection component connects the fingerprint identification unit and the control circuit unit.

18. The method for manufacturing the fingerprint identification device according to claim 17, wherein the at least one thermosensitive wire layer comprises a first thermosensitive wire layer and a second thermosensitive wire layer, the first thermosensitive wire layer comprises a plurality of longitudinal thermosensitive wires, the second thermosensitive wire layer comprises a plurality of transverse thermosensitive wires, and the longitudinal thermosensitive wires and the transverse thermosensitive wires intersect to define a plurality of sensing regions.

19. The method for manufacturing the fingerprint identification device according to claim 18, wherein a material of the longitudinal thermosensitive wires and a material of the transverse thermosensitive wires are selected from the group consisting of at least one of copper, silver, nickel, platinum, a cobalt base alloy, a nickel base alloy, and a ferrous alloy.

20. The method for manufacturing the fingerprint identification device according to claim 18, wherein the fingerprint identification unit further comprises a substrate and an insulating layer, the first thermosensitive wire layer and the second thermosensitive wire layer are disposed on the substrate, and the insulating layer is disposed at an intersection of the longitudinal thermosensitive wires and the transverse thermosensitive wires.
